(19) United States
(12) Patent Application Publication
(10) Pub. No.: US 2020/0048056 A1
(43) Pub. Date: Feb. 13, 2020

(54) JACK MECHANISM WITH IMPROVED SAFETY FEATURES

(71) Applicant: B&B Steel Products, Houston, TX (US)

(72) Inventor: Andrew Bush, Houston, TX (US)

(73) Assignee: B&B Steel Products, Houston, TX (US)

(21) Appl. No.: 16/490,415

(22) PCT Filed: Mar. 2, 2018
(86) PCT No.: PCT/US2018/020611

§ 371 Date: Aug. 30, 2019

Related U.S. Application Data
(60) Provisional application No. 62/466,194, filed on Mar. 2, 2017.

(51) Int. Cl. B66F 3/08

(52) U.S. Cl. CPC B66F 3/08

(57) ABSTRACT

A pipe jack or jack mechanism. The jack mechanism can include a base structure that can include a substantially vertical support member and a plurality of legs angularly disposed therefrom. An elevation member can be configured to move within the substantially vertical support member. A safety ring that can be generally circular can be disposed about an outer perimeter of the elevation member and can extend outwardly therefrom. An annular lock can be adjustably disposed about the outer perimeter of the elevation member and can be positioned below the safety ring. A stop gap can be positioned between the safety ring and the annular lock. A block cap can be disposed on a bottom portion of the substantially vertical support member to prevent the elevation member from extending beyond an end of the substantially vertical support member.

### CROSS REFERENCE TO RELATED APPLICATION

This is a National Stage Application under 35 U.S.C. § 371 of PCT/US2018/020611, filed on Mar. 2, 2018, which claims priority to U.S. Provisional Patent Application having Application No. 62/466,194, filed on Mar. 2, 2017, which is incorporated by reference herein.

### BACKGROUND

### Field

Embodiments described generally relate to supporting devices, and more particularly, relating to a jack stand for supporting a pipe or other objects.

### Description of the Related Art

Pipe jacks or jack stands have been used to support a length of pipe or other types of workpieces that require support and stabilization. Such pipe stands are typically used by welders to elevate a pipe or section of piping so the pipe sections can be welded together or other fittings can welded to the pipe. A conventional pipe jack includes a stand for resting against a floor structure, and an elevating head member that supports the pipe or other workpiece. The elevating head member is manually raised and lowered to manipulate the height of the supported pipe or other workpiece above the floor structure.

A section of pipe can weigh hundreds of pounds, creating real safety concerns to the welder in the event of a failure or slippage. Without proper safety mechanisms, the elevating head member can collapse or separate from the pipe stack, causing serious injury to personnel nearby. There is a need, therefore, for new and improved pipe or jack stands that are safer to use.

### SUMMARY

A pipe jack or jack mechanism and methods for using same are provided. In some examples, the jack mechanism can include a base structure that can include a substantially vertical support member and a plurality of legs angularly disposed therefrom. An elevation member can be configured to move within the substantially vertical support member. A safety ring that can be generally circular can be disposed about an outer perimeter of the elevation member and can extend outwardly therefrom. An annular lock can be adjustably disposed about the outer perimeter of the elevation member and can be positioned below the safety ring. A stop gap can be positioned between the safety ring and the annular lock. A block cap can be disposed on a bottom portion of the substantially vertical support member to prevent the elevation member from extending beyond an end of the substantially vertical support member.

### BRIEF DESCRIPTION OF THE DRAWINGS

FIG. 1 depicts a schematic view of an illustrative jack mechanism, according to one or more embodiments described.

FIG. 2 depicts an enlarged schematic view of an elevation member of the jack mechanism of FIG. 1, according to one or more embodiments described.

FIG. 3 depicts an enlarged schematic view of a lower section of the jack mechanism of FIG. 1, according to one or more embodiments described.

FIG. 4 depicts an enlarged schematic view of a safety feature on the jack mechanism of FIG. 1, according to one or more embodiments described.

FIG. 5 depicts an enlarged schematic view of a safety feature on the jack mechanism of FIG. 1, according to one or more embodiments described.

### DETAILED DESCRIPTION

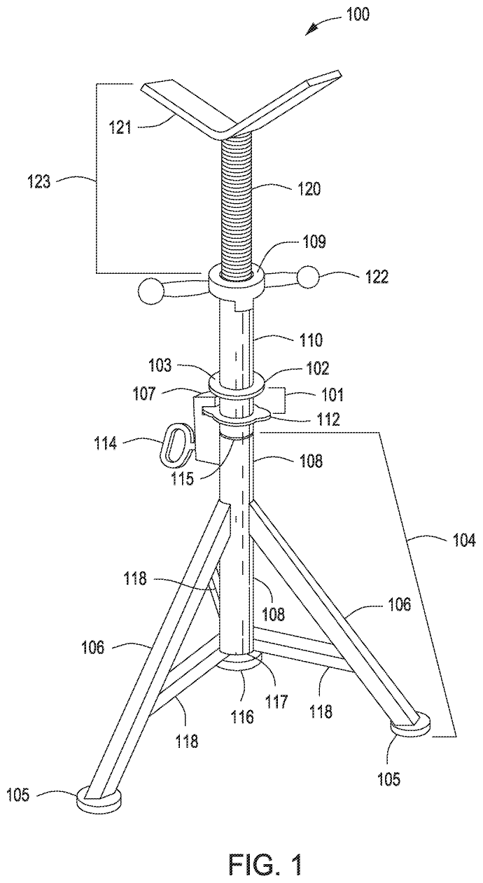

FIG. 1 depicts a schematic view of an illustrative jack mechanism 100, according to one or more embodiments. The jack mechanism 100 can include a base structure 104, a telescoping or elevation member 110, and a workpiece support member 123. The workpiece support member 123 can be disposed on a first end of the elevation member 110, and the base structure 104 can be disposed on a second end of the elevation member 110.

The base structure 104 can include a substantially vertical support member or tube 108 that can be supported using any number of legs 106 (three are shown). Each leg 106 can extend from the base structure 104 in an angular relation to one another. For example, the vertical support member 108 can include a plurality of legs 106 (three are shown) angularly disposed therefrom. One or more generally horizontal supports 118 can be disposed near a bottom portion 117 of the substantially vertical support member 108. The generally horizontal supports 118 can be connected to the substantially vertical support member 108 at a first end thereof and an adjacent leg 106 at a second end thereof. In some examples, each leg 106 can be welded or otherwise fixed to the support member 108. In other examples, one or more legs 106 can be attached to the support member 108 using a hinged type mechanism that can allow the legs 106 to fold to a substantially parallel relation with the support member 108 for easy storage and/or transportation. Each support leg 106 can be provided with one or more footings or support pads 105 disposed on the bottom thereof to provide a more stable engagement with a floor or other work surface.

The elevation member 110 can be sized and shaped to fit within the substantially vertical support member 108, allowing the elevation member 110 to move linearly, i.e. in a vertical direction. The substantially vertical support member 108 and elevation member 110 can have any complementary cross sectional shape, including circular, oval, elliptical, or polygonal, which allow the two components 108, 110 to move axially relative to one another. The substantially vertical support member 108 and the elevation member 110 can both have a circular cross section that allows the two components 108, 110 to rotate relative to one another. For example, the substantially vertical support member 108 and the elevation member 110 can both be cylindrical tubes. The elevation member 110 can have at least a lower portion thereof having a smaller outer diameter that can fit within the inner diameter of the substantially vertical support member 108.

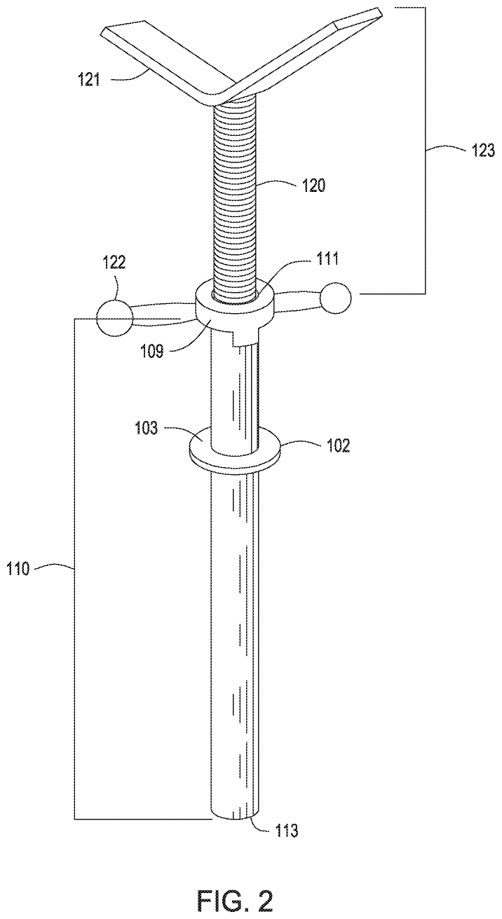

FIG. 2 depicts an enlarged schematic view of the elevation member 110 and the workpiece support member 123. The elevation member 110 can have a first or upper end 111 that is opposite a second or lower end 113. In a preferred embodiment, the elevation member 110 can be a tubular, and can be fabricated from a smooth pipe, i.e. a pipe that is not threaded, or a threaded pipe. The elevation member 110 can have a total length, as measured from the first end 111 to the second end 113, of about 4 inches to about 60 inches, about 8 inches to about 55 inches, about 12 inches to about 50 inches, or about 16 inches to about 45 inches, depending, at least in part, on the service and intended use of the jack. The total length of the elevation member 110 also can be about 6 inches, about 12 inches, or about 18 inches to about 24 inches, about 36 inches, or about 60 inches.

A block or safety ring 102 can be disposed about the outer perimeter of the elevation member 110. The safety ring 102 provides a safety feature to eliminate a pinch point between the base structure 104 and the support member 123. In some examples, the safety ring 102 can be an annular member having a substantially flat surface or platform 103 that extends outwardly from the elevation member 110. The width of the platform 103 can vary but should be sufficient to shield a human hand from contact below. For example, the width of the platform 103 can range from about 0.5 inches, about 0.75 inches, or about 1 inch to about 1.25 inches, about 1.5 inches, or about 3 inches or more.

In some examples, the safety ring 102 can be welded to the elevation member 110. In other examples, the safety ring 102 also can be adjustably disposed about the outer perimeter of the elevation member 110. For example, the safety ring 102 can be attached and held in a desired location by any suitable clamp, screw, or other removable device. In another example, the safety ring 102 can be attached and held in a desired location via threads that can be configured to engage complimentary threads about the outer perimeter of the elevation member 110.

The safety ring 102 can be disposed about the outer perimeter of the elevation member 110 at a position or height that is about 10% to about 50%, about 15% to about 45%, about 20% to about 40%, or about 25% to about 35% of the total length of the elevation member 110. For example, the safety ring 102 can be disposed about the outer perimeter of the elevation member 110 at a position of up to about 50%, up to about 45%, up to about 40%, up to about 35%, up to about 30%, up to about 25%, up to about 20%, up to about 15%, or up to about 10% of the total length of the elevation member 110. In another example, the safety ring 102 can be disposed about the outer perimeter of the elevation member 110 at a position or height that is about 5%, about 10%, about 15%, about 20%, or about 25% to about 30%, about 35%, about 40%, about 45%, or about 50% of the total length of the elevation member 110 relative to the first end 111. For example, an elevation member 110 having a length of about 24 inches could have the safety ring 102 disposed about the outer perimeter thereof about 1.2 inches to about 12 inches from the first end 111 thereof. As such, in some examples, the safety ring 102 can be disposed about the outer perimeter of the elevation member 110 at a position that is closer to the first end 111 of the elevation member 110 than the second end 113 of the elevation member 110.

The safety ring 102 can provide or serve as a shield that can prevent or at least substantially minimize the risk of hand injuries during operation or manipulation of the jack mechanism 100. For example, while gripping an upper portion of the elevation member 110 (i.e. the portion of the elevation member 110 above the safety ring 102 and below the support member 123), the safety ring 102 can provide safe placement support for the operator's hands that can prevent the operator's hands from sliding down the elevation member 110.

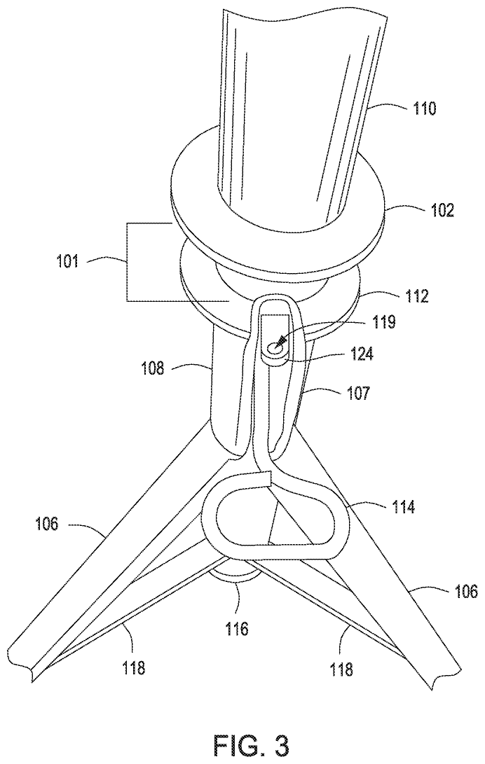

FIG. 3 depicts an enlarged schematic view of a lower section of the jack mechanism 100, providing yet another safety feature of the jack mechanism 100. An annular lock, lock ring, or annular lock ring 112 can be positioned about the substantially vertical support member 108 to assist the vertical placement and retention of the elevation member 110 relative to the support member 108. The annular lock 112 can be relatively flat and can have an opening formed therethrough. The opening of the annular lock 112 can be sized and shaped to fit around the outer surface of the elevation member 110. For example, if the elevation member 110 is a tubular having a circular cross section, the opening of the annular lock 112 can also be generally circular having an inner diameter slightly larger than the outer diameter of the tubular elevation member 110.

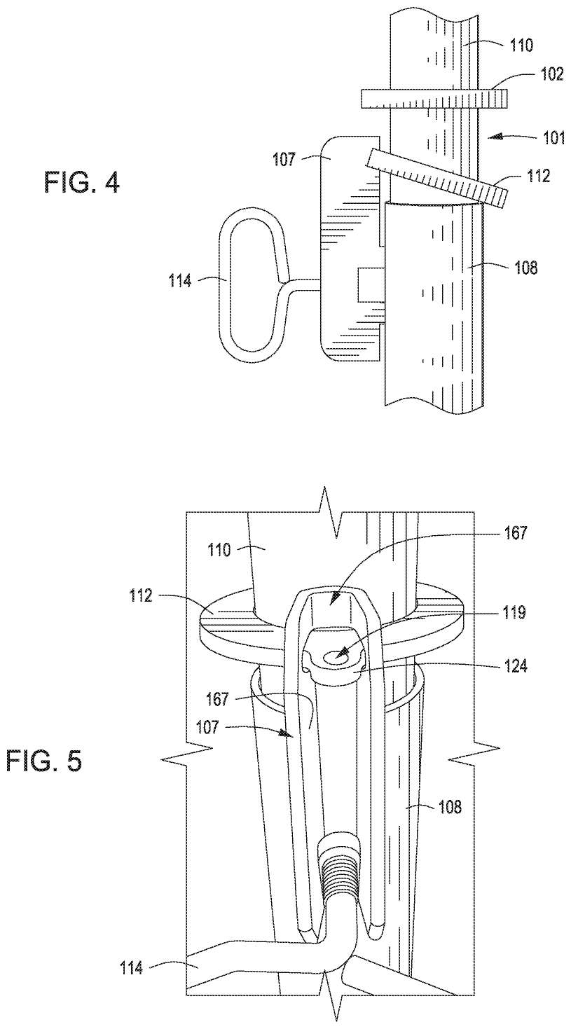

A retaining mechanism or retainer 107 can be disposed on the substantially vertical support member 108, near a first end or top portion 115 thereof (see FIG. 1), and can work in conjunction with the annular lock 112 to secure and hold the annular lock 112 to the jack mechanism 100, as depicted in FIGS. 4 and 5. Any portion of the retainer 107 can be welded or otherwise disposed on an outer surface of the support tube 108. The retainer 107 can further include a notch or groove 167 formed therein that is capable of receiving at least a portion of the annular lock 112. The notch or groove 167 can be an elongated, void, or hollowed out area within the retainer 107. The annular lock 112 can include one or more tabs or other extensions 124 integral therewith and/or appended therefrom that can be at least partially inserted into the notch or groove 167 of the retainer 107.

The extension 124 can hinge, pivot, or otherwise move up and down within the retainer 107 to allow the annular lock 112 itself to hinge, pivot, or otherwise move up and down relative to the substantially vertical support member 108. A pin or other clamp type mechanism, such as a pivot pin for example, can be inserted through an optional hole 119 that can be formed in the extension 124 of the annular lock 112 as an extra measure to secure the annular lock 112 to the jack mechanism 100. Such pin or other clamp type mechanism can be inserted through the hole 119 defined by the extension 124 and within the notch or groove 167 of the retainer 107 to prevent the annular lock 112 from disengaging from the retainer 107 during use or storage of the jack mechanism 100.

When the annular lock 112 is in a generally straight or horizontal position, i.e., parallel to the floor or other work surface when the one or more footings or support pads 105 are located thereon, there is sufficient clearance within the opening of the annular lock 112 to allow the elevation member 110 to freely move up and down, within the substantially vertical support member 108 of the base structure 104. When the annular lock 112 is angled downward relative to the elevation member 110, the annular lock 112 can directly contact and bite down on the outer surface of the elevation member 110 to prevent the elevation member 110 from moving downward relative to the substantially vertical support member 108 of the base structure 104. The weight of the jack mechanism above the annular lock 112, including any weight of the supported object, e.g., pipe, adds additional downward force, allowing the inner periphery of the annular lock 112 to bite and hold against the elevation member 110. The greater the downward load that is directed onto the annular lock 112, the more the annular lock 112 bites the outer surface of the substantially vertical support member 108.

Upward force on the annular lock 112 can cause the annular lock 112 to release the locking engagement with the elevation member 110. Upon release of the annular lock 112 from the elevation member 110, the elevation member 110 can move up and down relative to the substantially vertical support member 108. The annular lock 112 can help prevent injuries by securing the elevation member 110 in a locked position, thereby minimizing slippage during the manipulation or operation of the jack mechanism 100.

The annular lock 112 is designed to utilize a significant downward force or stress to hold a significant amount of weight. It is inherently a place that can cause injury to a finger or other portion of the hand if crushed against the annular lock 112, or worse if a finger finds its way into the space between an inner surface of the annular lock 112 and a surface of the elevation member 110. As mentioned above, the safety ring 102 provides an additional safety feature to help prevent a finger or hand wrapped around the telescoping elevation member 110 from coming in contact with the annular lock 112. The safety ring 102 creates a grip or hand support area thereabove on the elevation member 110 as well as a shield to prevent a hand from slipping off the hand support area, preventing or substantially minimizing human contact with the annular lock 112.

The jack mechanism 100 can include yet another safety feature in the form of a spacer or stop gap 101 below the safety ring 102. Referring again to FIG. 1, the spacer or stop gap 101 is a distance or length of the lower portion of the elevation member 110 (i.e., the portion of the elevation member located below the safety ring 102). The stop gap 101 can about 5 inches, about 4.5 inches, about 4 inches, about 3.5 inches, about 3 inches, or about 2.5 inches in length. The stop gap 101 also can range from about 1 inch to about 5 inches, from about 1.5 inches to about 4.5 inches, from about 2 inches to about 4 inches, or from about 2.5 inches to about 3.5 inches. The stop gap 101 can further prevent or substantially minimize the risk of hand injury by creating a void space between the safety ring 102 and the annular lock 112.

The distance provided by the stop gap 101 can be formed by using a base cap 116 or other element that stops the movement of the elevation member 110. The base cap 116, for example, can be located at or near the bottom 117 of the substantially vertical support member 108. The base cap 116 can be any shape, including, but not limited to circular (as shown), oval, square, or rectangular. The base cap 116 can be welded directly to the bottom of the substantially vertical support member 108, or it can be located anywhere within the support member 108. The base cap 116 sits below the elevation member 110 and acts as a stop or block to prevent the elevation member 110 from moving past. The base cap 116 stops the downward movement of the elevation member 110 and prevents the elevation member 110 from passing through the bottom portion 117 of the substantially vertical support member 108, which could potentially cause a serious foot injury if the operator's foot is positioned underneath the bottom portion 117 of the vertical substantially vertical support member 108. The placement of the base cap 116 can also prevent or substantially minimize hand injuries by preventing the safety ring 102 from contacting the annular lock 112 during use. Said another way, the placement of the base cap 116 can determine the length of the space gap 101. The distance between the base cap 116 and the safety ring 102 should be sufficient to provide the space gap 101 with at least 2 inches, if not at least 3″, 5″, or 7″ or more along the length of the elevation member 110.

The substantially vertical support member 108 and/or the elevation member 110 can include a plurality of vertically spaced holes or apertures. In some examples, a retainer pin 114 or other similar device can be inserted through a pair of aligned holes in the elevation member 110 and the substantially vertical support member 108 to secure the elevation member 110 to the substantially vertical support member 108. The holes on either the elevation member 110 or the substantially vertical support member 108 or both can be threaded. At least a portion of the retainer pin 114 also can be threaded. Accordingly, in some examples the retainer pin 114 can be screwed into the threaded holes of the elevation member 110, the threaded holes of the substantially vertical support member 108, or both. The retainer pin 114 can further prevent movement of the elevation member 110, whether linear or rotational, relative to the substantially vertical support member 108. In some examples, the retainer pin 114 can be screwed into a threaded hole of the substantially vertical support member 108 and can contact an outer surface of the elevation member 110.

The jack mechanism 100 can further include one or more support members 123 disposed on a first or upper end thereof. The support member 123 can be disposed on top of the elevation member 108. The support member 123 can include a head 121 disposed atop a generally vertical stem 120. The head 121 can be any one or more interchangeable components, including, but not limited to a V-head cradle (as shown), a hold-down head, a roller, a conveyor roller, or a ball transfer sleeve. The stem 120 can be positioned within the first end 111 of the elevation member 110. The stem 120 can be externally threaded to engage with an internally threaded adjustment nut 109 that can be turned to more finely adjust the height of the stem 120 relative to the elevation member 110. The adjustment nut 109 can be positioned at or near the first end 111 of the elevation member 110 and can be turned to adjust the vertical orientation of the head 121. Any type of screw threads can be used for this purpose, including all ACME type threads. Rotational movement of the adjustment nut 109 raises and lowers the head 121 relative to the elevation member 110. The adjustment nut 109 can further include one or more handles 122 integral therewith or appended therefrom to assist turning the adjustment nut 109.

The jack mechanism 100 can be fabricated from one or more metallic and/or non-metallic materials. Suitable metallic materials, for example, can include, but are not limited to, steel, stainless steel, aluminum, copper, nickel, cast iron, galvanized or non-galvanized metals, or any alloys or mixtures thereof. The overall dimensions of the jack mechanism 100 can vary. For example, the dimensions (length (L)×width (W)×height (H)) of the jack mechanism 100 can be up to about 40 inches×22 inches×22 inches, up to about 25 inches×18 inches×18 inches, or up to about 16 inches×15 inches×inches 15. In another example, the dimensions (height (H)×width (W)×depth (D)) of the jack mechanism 100 can be up to about 72 inches×22 inches×22 inches, up to about 60 inches×18 inches×18 inches, or up to about 16 inches×15 inches×inches 15. Additionally, the jack mechanism 100 can withstand a weight capacity of about 3,500 pounds or more. For example, the jack mechanism 100 can withstand a weight capacity of less than 500 pounds up to about 3,500 pounds, from about 1,000 pounds up to about 3,000 pounds, or from about 1,500 pounds up to about 2,500 pounds.

Embodiments of the present disclosure further relate to any one or more of the following paragraphs:

1. A jack mechanism comprising: a base structure comprising a substantially vertical support member and a plurality of legs angularly disposed therefrom; an elevation member configured to move within the substantially vertical support member; a safety ring, wherein the safety ring is generally circular and disposed about an outer perimeter of the elevation member and extends outwardly therefrom; an annular lock, wherein the annular lock is adjustably disposed about the outer perimeter of the elevation member, and positioned below the safety ring; a stop gap positioned between the safety ring and the annular lock; and a block cap disposed on a bottom portion of the substantially vertical support member to prevent the elevation member from extending beyond the end of the substantially vertical support member.

2. The jack mechanism according to paragraph 1, wherein the safety ring is fixed about the outer perimeter of the elevation member.

3. The jack mechanism according to paragraph 1 or 2, wherein the elevation member is a tubular member.

4. The jack mechanism according to any one of paragraphs 1 to 3, wherein the annular lock is adjustably disposed about the outer perimeter of the elevation member and is located at a position that is no higher than 80% of a total length of the elevation member.

5. The jack mechanism according to any one of paragraphs 1 to 3, wherein the annular lock is adjustably disposed about the outer perimeter of the elevation member at a height that is about 15% to about 80% of a total length of the elevation member.

6. The jack mechanism according to any one of paragraphs 1 to 5, wherein the safety ring is disposed about the outer perimeter of the elevation member at a height that is no more than 50% of a total length of the elevation member.

7. The jack mechanism according to any one of paragraphs 1 to 6, wherein the safety ring is disposed about the outer perimeter of the elevation member at a height that is about 10% to about 50% of a total length of the elevation member.

8. The jack mechanism according to any one of paragraphs 1 to 7, further comprising a workpiece support member comprising a head and a generally vertical threaded tube, wherein the head is fixedly disposed atop the threaded tube, and wherein the threaded tube is configured to be positioned within a top portion of the elevation member.

9. The jack mechanism according to paragraph 8, wherein the workpiece support is a V-head support, a hold-down head support, a wheeled roller head support, a conveyor roller head support, or a ball transfer sleeve support.

10. The jack mechanism according to any one of paragraphs 1 to 9, further comprising an adjustment nut disposed about the outer perimeter of a top portion of the elevation member, wherein the adjustment nut has at least two opposing handles fixedly disposed thereupon.

11. The jack mechanism according to any one of paragraphs 1 to 10, further comprising a lock retaining element disposed proximate an upper end of the substantially vertical support member, the lock retaining element configured to receive a portion of the annular lock.

12. The jack mechanism according to any one of paragraphs 1 to 11, wherein the elevation member is able to move linearly within the substantially vertical support member.

13. The jack mechanism according to any one of paragraphs 1 to 12, wherein the elevation member is able to rotate within the substantially vertical support member.

14. T The jack mechanism according to any one of paragraphs 1 to 13, further comprising a retainer pin for securing the elevation member to the substantially vertical support member.

15. The jack mechanism according to any one of paragraphs 1 to 14, wherein the elevation member and the substantially vertical support member each comprises a plurality of holes formed therethrough.

16. The jack mechanism according to paragraph 14 or 15, wherein the retainer pin is inserted through an aligned set of holes in the elevation member and the substantially vertical support member.

17. The jack mechanism according to any one of paragraphs 1 to 16, wherein the substantially vertical support member is a cylindrical tube.

18. A jack mechanism comprising: a base structure comprising a substantially vertical support member and a plurality of legs angularly disposed therefrom; an elevation member configured to move within the substantially vertical support member; a safety ring disposed about an outer perimeter of the elevation member that extends outwardly therefrom; an annular lock adjustably disposed about the outer perimeter of the elevation member and positioned below the safety ring; a stop gap positioned between the safety ring and the annular lock; and a block cap disposed on a bottom portion of the support tube to prevent the elevation member from extending beyond an end of the substantially vertical support member.

19. The jack mechanism according to paragraph 18, wherein a first end of the elevation member is located outside of the substantially vertical support member.

20. The jack mechanism according to paragraph 18 or 19, wherein a second end of the elevation member is disposed within the substantially vertical support member.

21. The jack mechanism according to paragraph 19 or 20, wherein the safety ring is disposed about the outer perimeter of the elevation member at a position that is about 5% to about 50% of a total length of the elevation member relative to the first end of the elevation member.

22. The jack mechanism according to paragraph 19 or 20, wherein the safety ring is disposed about the outer perimeter of the elevation member at a position that is closer to the first end of the elevation member than the second end of the elevation member.

23. The jack mechanism according to any one of paragraphs 18 to 22, wherein the safety ring is fixed about the outer perimeter of the elevation member.

24. The jack mechanism according to any one of paragraphs 18 to 23, wherein the elevation member is a tubular member.

25. The jack mechanism according to any one of paragraphs 18 to 24, wherein the vertical support member is a tubular member.

26. The jack mechanism according to any one of paragraphs 20 to 25, wherein the annular lock is adjustably disposed about the outer perimeter of the elevation member and is located at a position away from the second end of the elevation member that is at least 10%, at least 15%, or at least 20% of a total length of the elevation member.

27. The jack mechanism according to any one of paragraphs 18 to 26, further comprising a workpiece support member comprising a head and a generally vertical threaded tube, wherein the head is fixedly disposed atop the threaded tube, and wherein the threaded tube is configured to be positioned within a top portion of the elevation member.

28. The jack mechanism according to paragraph 27, wherein the workpiece support is a V-head support, a hold-down head support, a wheeled roller head support, a conveyor roller head support, or a ball transfer sleeve support.

29. The jack mechanism according to any one of paragraphs 18 to 28, further comprising an adjustment nut disposed about the outer perimeter of a top portion of the elevation member, wherein the adjustment nut has at least two opposing handles fixedly disposed thereupon.

30. The jack mechanism according to any one of paragraphs 18 to 29, further comprising a lock retaining element disposed proximate an upper end of the substantially vertical support member, the lock retaining element configured to receive a portion of the annular lock.

31. The jack mechanism according to any one of paragraphs 18 to 30, wherein the elevation member is able to move linearly within the substantially vertical support member.

32. The jack mechanism according to any one of paragraphs 18 to 31, wherein the elevation member is able to rotate within the substantially vertical support member.

33. The jack mechanism according to any one of paragraphs 18 to 32, further comprising a retainer pin for securing the elevation member to the substantially vertical support member.

34. The jack mechanism according to any one of paragraphs 18 to 33, wherein the elevation member and the substantially vertical support member each comprises a plurality of holes formed therethrough.

35. The jack mechanism according to paragraph 33 or 34, wherein the retainer pin is inserted through an aligned set of holes in the elevation member and the substantially vertical support member.

36. The jack mechanism according to any one of paragraphs 18 to 35, wherein the substantially vertical support member is a cylindrical tube.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A jack mechanism comprising:
a base structure comprising a substantially vertical support member and a plurality of legs angularly disposed therefrom;
an elevation member configured to move within the substantially vertical support member;
a safety ring, wherein the safety ring is generally circular and disposed about an outer perimeter of the elevation member and extends outwardly therefrom;
an annular lock, wherein the annular lock is adjustably disposed about the outer perimeter of the elevation member, and positioned below the safety ring;
a stop gap positioned between the safety ring and the annular lock; and
a block cap disposed on a bottom portion of the substantially vertical support member to prevent the elevation member from extending beyond an end of the substantially vertical support member.

2. The jack mechanism of claim 1, wherein the safety ring is fixed about the outer perimeter of the elevation member.

3. The jack mechanism of claim 1, wherein the elevation member is a tubular member.

4. The jack mechanism of claim 3, wherein the annular lock is adjustably disposed about the outer perimeter of the elevation member and is located at a position that is no higher than 80% of a total length of the elevation member.

5. The jack mechanism of claim 3, wherein the annular lock is adjustably disposed about the outer perimeter of the elevation member at a height that is about 15% to about 80% of a total length of the elevation member.

6. The jack mechanism of claim 1, wherein the safety ring is disposed about the outer perimeter of the elevation member at a height that is no more than 50% of a total length of the elevation member.

7. The jack mechanism of claim 1, wherein the safety ring is disposed about the outer perimeter of the elevation member at a height that is about 10% to about 50% of a total length of the elevation member.

8. The jack mechanism of claim 1, further comprising a workpiece support member comprising a head and a generally vertical threaded tube, wherein the head is fixedly disposed atop the threaded tube, and wherein the threaded tube is configured to be positioned within a top portion of the elevation member.

9. The jack mechanism of claim 8, wherein the workpiece support is a V-head support, a hold-down head support, a wheeled roller head support, a conveyor roller head support, or a ball transfer sleeve support.

10. The jack mechanism of claim 1, further comprising an adjustment nut disposed about the outer perimeter of a top portion of the elevation member, wherein the adjustment nut has at least two opposing handles fixedly disposed thereupon.

11. The jack mechanism of claim 10, further comprising a lock retaining element disposed proximate an upper end of the substantially vertical support member, the lock retaining element configured to receive a portion of the annular lock.

12. The jack mechanism of claim 10, wherein the elevation member is able to move linearly within the substantially vertical support member.

13. The jack mechanism of claim 10, wherein the elevation member is able to rotate within the substantially vertical support member.

14. The jack mechanism of claim 10, further comprising a retainer pin for securing the elevation member to the substantially vertical support member.

15. The jack mechanism of claim 14, wherein the elevation member and the substantially vertical support member each comprises a plurality of holes formed therethrough.

16. The jack mechanism of claim 15, wherein the retainer pin is inserted through an aligned set of holes in the elevation member and the substantially vertical support member.

17. The jack mechanism of claim 15, wherein the substantially vertical support member is a cylindrical tube.
